(19) United States
(12) Patent Application Publication
(10) Pub. No.: US 2010/0287077 A1
(43) Pub. Date: Nov. 11, 2010

(54) MANAGEMENT OF ACCOUNTS FOR COMMUNICATIONS SERVICES

(75) Inventor: Joachim WAHLBERG, Brakne-Hoby (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET L M ERICSSON (PUBL), Stockholm (SE)

(21) Appl. No.: 12/437,771

(22) Filed: May 8, 2009

(51) Int. Cl. H04M 15/00

(52) U.S. Cl. 705/34

(57) ABSTRACT

An accounts management node (20) of a communications system comprises a computer (30) configured, after initiation of a current cyclical job, to use computer-executable decision logic for determining what appropriate output action is to be taken with respect to plural affected accounts. The accounts management node (20) further comprises a generator (22) under control of the computer (30) and configured to automatically generate an appropriate output action for each affected account.

### TECHNICAL FIELD

This invention pertains to communications, and particularly to methods and apparatus for managing accounts for subscribers of communications services.

### BACKGROUND

Communications companies (e.g., telecommunications operators) typically enlist or obtain subscribers for the companies' services. For each such subscriber the company generally maintains information for a subscriber account in a corresponding record of a database or the like. Either periodically or upon initiative of the company, the company uses the database to conduct a mass operation of sending some sort of notification to its subscribers. The notification sending operation may involve some (a subset) or all of the subscribers, and typically the notifications of the same sending operation are fairly uniform in purpose and content. For example, one type of separate notification sending operation may be a billing or invoicing operation, whereas another type of separate notification sending operation may be an information distribution operation (apprising of such things as changes of service or terms of service, advertising of additional service options, or the like). Some notification sending operations are performed cyclically, e.g., periodically (such as once per month, for example) or upon occurrence of predetermined events or triggers.

Some subscribers/customers may pay a flat fee for communications services. Many customers or subscribers have an account which is structured or arranged (e.g., by contract), at least in part, so that the customer is assessed a communications fee which is dependent upon an amount of time or other network resource which is utilized by the customer (e.g., degree or quality of service, calendar or clock time of service, for example). For some customers the fee or charge reduces a prepaid amount existing in the customer's account (in which case it is known as a prepaid account). Alternatively, the fee or charge accumulates against the credit of the customer and is presented for subsequent payment (in which case it is known as a postpaid account).

For charging purposes the communications network provides some type of monitoring of resource consumption by the customers. The monitoring can occur at faculties or nodes involved in setup or administration of the services (e.g., of a call or connection). The resource monitoring and/or other types of reports from the communications network are communicated to a real-time charging system which associates the call or session with a customer's account as maintained by the charging system, and may send reports (e.g., Call Detail Record (CDR) files) to a billing system which is maintained by the communications operator. The billing system likewise has an account which is associated with the customer, and which includes other (e.g., historical) information. Examples of charging and billing systems are described, e.g., in U.S. patent application Ser. No. 12/256,990, entitled Real-Time Flexible Account Selection for Communications, which is incorporated herein by reference.

As indicated above, each notification sending operation performed by a communications company is essentially of uniform nature. For example, a communications company performs a billing or invoicing operation distinctly and separately (e.g., in different jobs) from an information distribution operation. Moreover, the billing or invoicing operations are typically segregated or stratified into different operations depending on certain characteristics, e.g., account characteristics. For example, separate billing or invoicing operations are performed for post-paid accounts on the one hand, and pre-paid accounts on the other. Many of these notification sending operations are performed repetitively and even cyclically for the member accounts, yet they are separately performed in view of some characteristic or differentiator (e.g., either an account or operation type differentiator).

### SUMMARY

In one of its aspects, the technology disclosed herein comprises an accounts management node of a communications system. The node comprises a computer comprising one or more processors configured, after initiation of a current cyclical job, to use computer-executable decision logic for determining what appropriate output action is to be taken with respect to plural affected accounts. The node further comprises a generator under control of the computer and configured to automatically generate an appropriate output action for each affected account.

In an example embodiment, the computer is configured to execute instructions stored on a computer-readable medium for performing the acts of: (1) determining which of plural cyclical jobs is to be executed as the current job upon attainment of an input time; (2) determining which of plural subscriber accounts are the plural affected accounts associated with the current job; and then (3) in the course of execution of the current job, for each of the plural affected accounts, employing the computer-executable decision logic to make a separate determination of an appropriate output action to be taken for the respective affected account, the determination being made in dependence upon subscriber-related information stored in a computer-readable database.

In an example embodiment the computer of the node is further configured to execute the instructions stored on the computer-readable medium to employ the computer-executable decision logic to make a separate determination for each affected account, and wherein the subscriber-related information is not uniform for all affected accounts associated with the current job.

In an example embodiment, the computer is configured to execute the instructions stored on the computer-readable medium whereby act (1) comprises comparing the input time with respective trigger times for each of the plural cyclical jobs, a trigger time being stored in a computer-readable record for the current job. The computer is further configured to execute the instructions stored on the computer-readable medium for performing the acts of: (a) using criteria stored in the computer-readable record for the current job to calculate a new trigger time for the current job; (b) storing the new trigger time in the record for the current job as the trigger time; and (c) repeating act (1) using the new trigger time as the trigger time for the current job. In an example implementation, the computer is further configured to execute the instructions stored on the computer-readable medium to perform acts (a)-(c) after acts (2)-(4) have been performed for all affected accounts associated with the current job.

In an example embodiment the computer is configured to execute the instructions stored on the computer-readable medium to set a flag in a computer-readable record for the current job that the current job is being executed.

In an example implementation, the computer is further configured to execute the instructions stored on the computer-readable medium, while performing any of act (1) through act (4) for a first current task, to initiate act (1) with a new input time as the input time to determine a further current task, and then to perform act (2) through act (4) with respect to the further current task.

In an example embodiment, at least one of the affected accounts for the current job is a pre-paid account

In an example embodiment, at least one of the affected accounts for the current job is a post-paid account

In an example embodiment, at least some of the affected accounts for the current job are pre-paid accounts and at least some of the affected accounts for the current job are post-paid accounts.

In an example embodiment, the appropriate output action for at least one of the affected accounts comprises generation of a notification.

In an example embodiment, the notification is an electronic notification.

In an example embodiment, the notification is a printed notification.

In an example embodiment, the appropriate output action for at least one of the affected accounts comprises performance of a financial transaction.

In another of its aspects, the technology disclosed herein concerns a method of managing accounts of a communications system and of operating an account management node of a communications system.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of a communications system comprising an accounts management node.

FIG. 2 is a flowchart showing basic, representative acts of steps performed by a communications account management method.

FIG. 3 is a diagrammatic view depicting various aspects of the method of FIG. 2.

FIG. 4 is a flowchart showing an example illustration of decision tree logic which is invoked by cycle management logic in accordance with an example embodiment.

FIG. 5 is a diagrammatic view showing example format and content fields of computer-readable records maintained or used by the accounts management node.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled or described as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

The technology disclosed herein pertains to generic cycle management which can be used for any kind of cycle management, either existing or future. The cycle management nodes and methods described herein can be pre-defined in some embodiments, but the node and its management methods and techniques are dynamically (re)configurable.

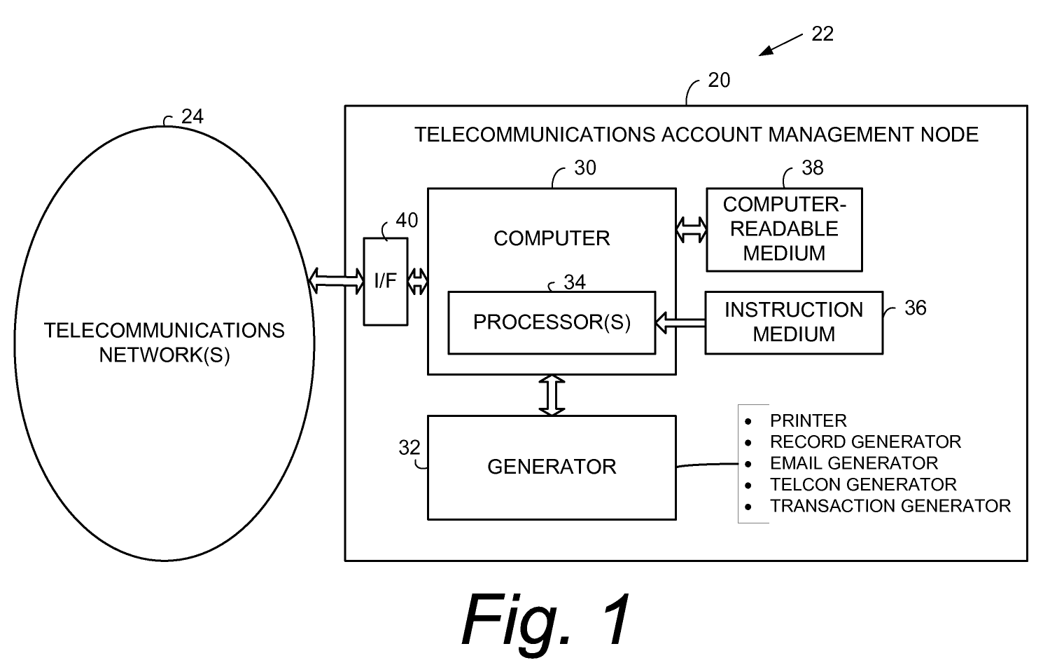

FIG. 1 shows an example embodiment of an accounts management node 20 of a communications system 22. The telecommunications system 22 typically comprises, in addition to accounts management node 20, a communications network 24. The communications network 24 can comprise any type of communications technology or type, including for example, a land-based communications network, a mobile (wireless) communications network (e.g., radio access network (RAN)), or combinations thereof. The accounts management node 20 can be, for example, a node which performs charging or billing operations for a telecommunications system, or can be included with or connected to other nodes which performing charging and/or billing services.

As shown in FIG. 1, accounts management node 20 comprises computer 30 and action or output generator 32. The computer 30 as shown and described herein is not limited to a stand-alone computer, but could also be a system of inter-connected, networked, or communicating computers. Moreover, it is to be understood that the computer 30 can comprise one or more processors 34 as that term is herein expansively elaborated. The processor(s) 34, and thus the computer 30, is configured to execute coded instructions (e.g., a programmed instruction set) stored in a computer-readable instruction medium 36. Moreover, the computer 30 (and its processor(s) 34) have access to various types of information stored in databases or the like which are generically depicted as computer-readable medium 38. Such information includes, for example, account information (e.g., an account record) for the numerous subscribers or customers of the telecommunications system. The computer 30 is connected to the communications network 24 through a suitable interface 40 which is configured to take into consideration characteristics of one or both of computer 30 and communications network 24.

The computer 30 can be schedule-prompted or otherwise requested to execute or perform various jobs. Of interest herein are the jobs performed by computer 30 which are cyclical in nature (e.g., repeated either periodically or upon repeated request, demand, or prompt). Each of these jobs are provided with a job identifier (“Cycle_Id”) and (optionally) a job name (“Cycle_name”). Of the various potential cyclical jobs, any particular job which is executing at a given time is known as a “current cyclical job”. Significantly, after initiation of a current cyclical job, computer 30 uses computer-executable decision logic for determining what appropriate output action is to be taken with respect to plural affected accounts to which the current cyclical job pertains. As explained herein, action generator 32 is under control of computer 30 and is configured to automatically generate an appropriate output action for each affected account.

Thus, at least in its aspects described herein, the computer 30 does not merely execute a batch job in which computer 30 knows in advance what (essentially uniform) actions are to be taken with respect to customer accounts. Rather, upon initiating the current cyclical job, computer 30 knows that the current cyclical job is to be run, but upon initiation does not yet know what action is to be taken with respect to the accounts that are affected by the current cyclical job. Moreover, the actions that are to be taken with respect to the accounts are not necessarily uniform, but rather are based on decision logic which is essentially separately and subsequently (after determination of which accounts are the affected account) invoked with respect to each affected account. For each affected account the decision logic can be conditional (e.g. conditionally based on information associated with the affected account).

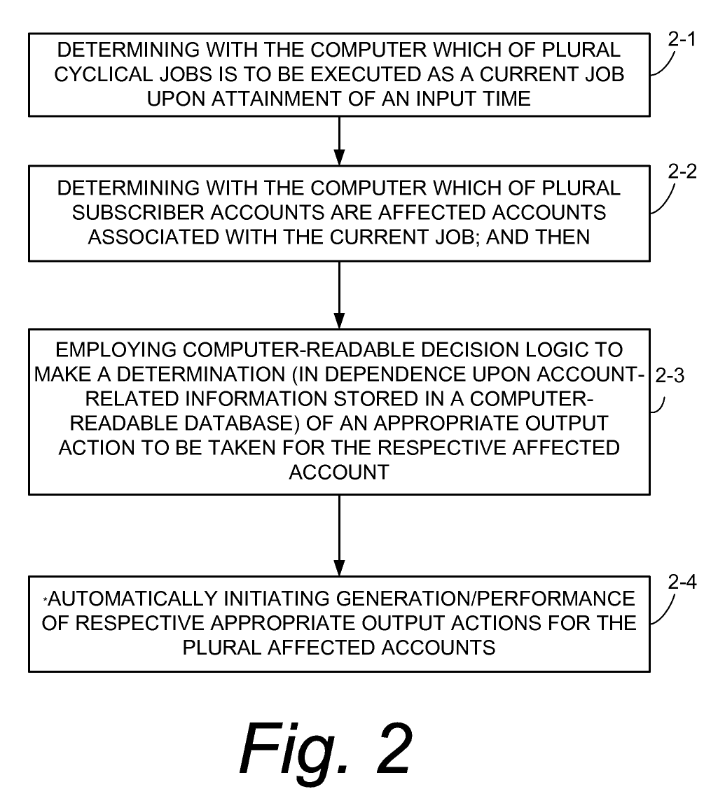

FIG. 2 shows basic, representative, non-limiting acts or steps which can be performed by accounts management node 20. Of these, the acts or steps which are performed by computer 30 can be performed as the processor(s) 34 execute the coded instructions stored in instruction medium 36. In an example embodiment or mode shown in FIG. 2, the computer performs the basic acts 2-1; 2-2; 2-3; and 2-4. Act 2-1 comprises determining which of plural cyclical jobs is to be executed as the current job upon attainment of an input time. Act 2-2 comprises determining which of plural subscriber accounts are the plural affected accounts associated with the current job. Act 2-3 follows act 2-2, and comprises, in the course of execution of the current job, for each of the plural affected accounts, employing the computer-executable decision logic to make a separate determination of an appropriate output action to be taken for the respective affected account. The determination by computer 30 of act 2-3 can be made in dependence upon subscriber-related information stored in a computer-readable database such as computer-readable medium 38. Act 2-4 shows the computer 30 automatically initiating generation/performance of respective appropriate output actions for the plural affected accounts.

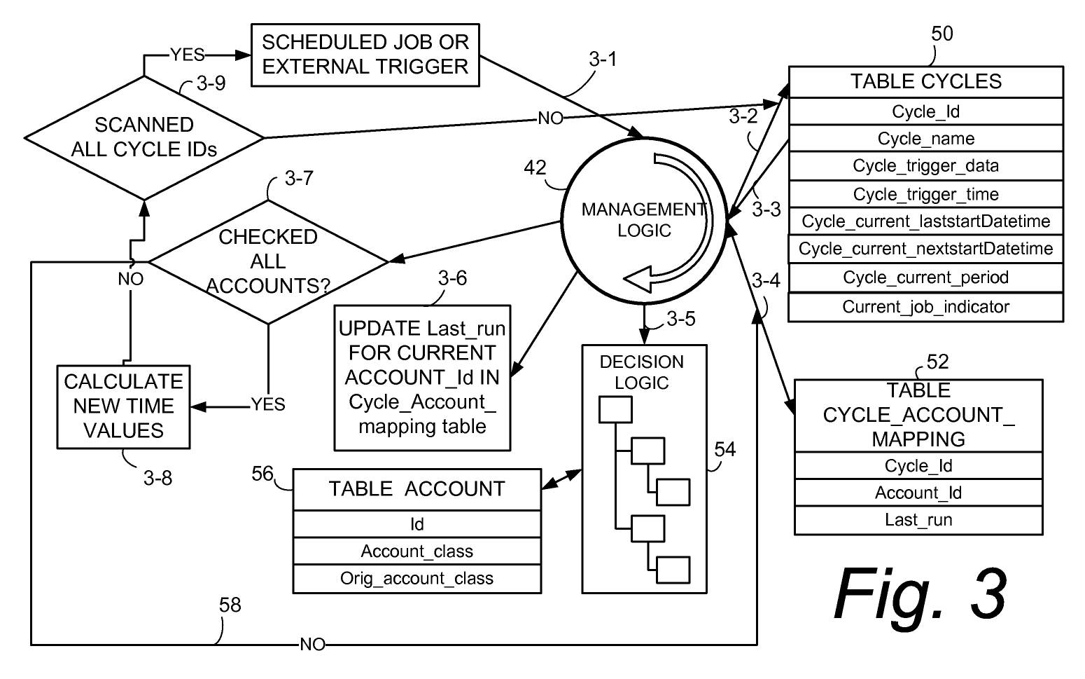

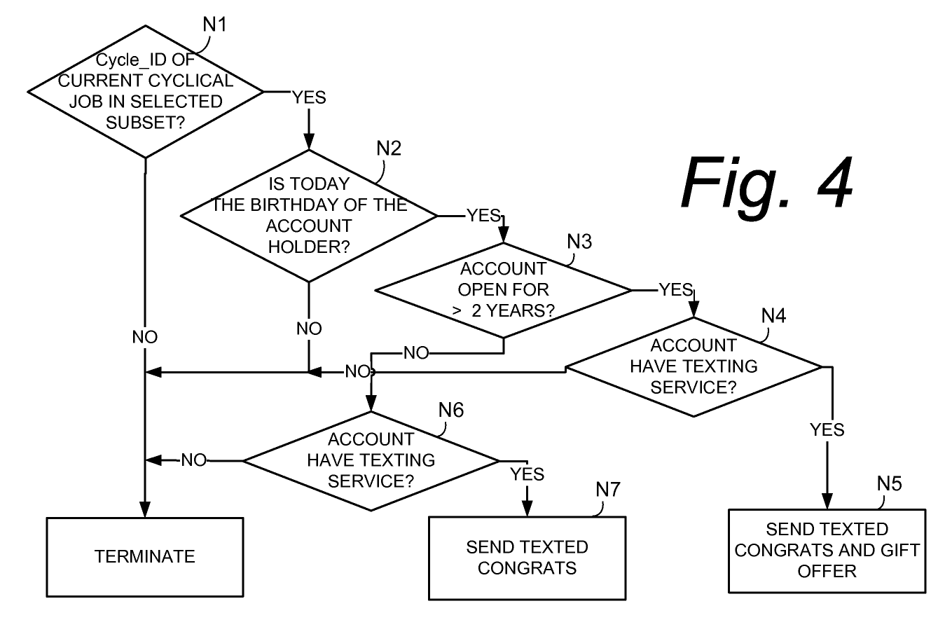

FIG. 3 shows in more detail certain example actions, steps, or events that can occur in an example implementation of the account management of the technology disclosed herein. Act 3-1 illustrates initiation of the overall accounts management technology, e.g., initiation of a management program or task or the like. The logic of the accounts management technology (e.g., cycle management logic) is represented by circular logic symbol 42. The cycle management logic 42 is started either according to scheduling (e.g., as a scheduled program or executable file), or by other triggers. Alternatively, the overall accounts management technology can be running essentially continually or constantly.

FIG. 3 further shows that cycle management logic 42 performs, both at start up and at other times thereafter, an act 3-2 of scanning to decide if any cyclical job (as identified by its Cycle-Id) has reached or passed a triggering point. In other words, act 3-2 comprises determining which of plural cyclical jobs is to be executed as the current job upon attainment of an input time. FIG. 3 further illustrates the scanning of act 3-2 involves consulting a table illustrated as Table Cycles 50. In particular, as act 3-2, logic 42 of the accounts management technology makes a comparison of the actual current date and time and a value Cycle_current_nextstartDateTime for each job of Table Cycles 50. If the actual current date and time equals or is subsequent to the value stored in a field Cycle_current_nextstartDateTime of Table Cycles 50 for any job, the cycle management logic 42 knows that it is time to execute, and does execute, such job as the current cyclical job (or, in the case of already or essentially simultaneously-triggered jobs, as one of the current cyclical jobs). Act 3-3 of FIG. 3 depicts notification of the determination of a match (e.g., the triggering of a current cyclical job) by return of the Cycle_Id of the current cyclical job to cycle management logic 42. Moreover, if a current cyclical job, e.g., a Cycle_Id, is triggered in act 3-2, a tag or other indicator may be set (e.g., in another field of Table Cycles 50) to indicate that associated Cycle_Id is a current cyclical job.

In the example format shown in FIG. 3, the Table Cycles 50 comprises eight fields for each job, it being understood that the contents of the Table Cycles 50 of FIG. 3 illustrates its fields for only one example job. For each job listed in Table Cycles 50, the seven fields of Table Cycles 50 are thus stored in relation to one another and to the Cycle_Id of the job. The eight example fields of Table Cycles 50 as shown in FIG. 3 are the following: Cycle_Id; Cycle_name; Cycle_trigger_date; Cycle_trigger_time; Cycle_current_laststartDateTime; Cycle_current_nextDateTime; Cycle_current_period; and current_job_indicator. Further descriptions of these eight fields of Table Cycles 50 are provided subsequently.

After determination at act 3-2 that a current cyclical job exists, as act 3-4 the cycle management logic 42 determines which of plural subscriber accounts are the plural affected accounts associated with the current job. In other words, cycle management logic 42 locates and identifies each subscription or account which belongs to or is associated with the current cyclical job. To do so, cycle management logic 42 checks or searches one or more tables such as the table illustrated as Table Cycle_Account_mapping 52 shown in FIG. 3. Table Cycle_Account_mapping 52 shows that each account has an account identifier (“Account_Id”). For each account the Table Cycle_Account_mapping 52 stores a relation between Cycle_Id, Account_Id, and a parameter Last_run.

In one example embodiment, the Table Cycle_Account_mapping 52 comprises a trilogy of related fields for each account, specifically the Cycle_Id, Account_Id, and Last_run fields. While FIG. 3 shows the trilogy of fields for only one account, for this example embodiment it will be understood that Table Cycle_Account_mapping 52 includes the comparable three fields for each account or subscriber. In other words, in this embodiment, the Table Cycle_Account_mapping 52 encompasses all accounts and provides the trilogy relation for each account. In this way the Table Cycle_Account_mapping 52 is searchable using the Cycle_Id of the current cyclical job for obtaining the particular accounts (as denoted by their Account_Id) for the affected accounts for the current cyclical job.

It will be appreciated that the account mapping table can be structured or formatted differently in other embodiments. For example, in an alternate embodiment a separate table such as Table Cycle_Account_mapping 52 can exist for each account, with each table having essentially only the three related fields pertinent to one account.

It should be understood from the foregoing that Table Cycle_Account_mapping 52, however formatted, can be composed so that one Account_Id is associated with one or more Cycle_Ids. Most often each Cycle_Id is associated with many Account_Ids, but can also be associated with one Account_Id.

Execution of the current cyclical job (having the identity referred to as Cycle_Id) can begin before act 3-4 (just described), but no later than act 3-5. Act 3-5 comprises cycle management logic 42 employing, for each of the plural affected accounts located at act 3-4, computer-executable decision logic 54 to make a separate determination of an appropriate output action to be taken for the respective affected subscriber or account. When consulted or evaluated with respect to an individual account (on the basis of Account Id), the computer-executable decision logic 54 is structured, ordered, or arranged so that its execution determines or selects an appropriate action to be taken with respect to such individual subscriber or account. The determination made by computer-executable decision logic 54 is made dependent upon at least one condition, and when more than one condition is involved the determination can obtain information pertinent to resolving the conditions from subscriber or account information stored in computer-readable medium 38.

For an example embodiment FIG. 3 illustrates the computer-executable decision logic 54 employed by cycle management logic 42 as comprising decision tree-type logic. In decision tree logic, a series of one or more conditions are evaluated, with the result of each evaluation leading to another branch of the tree, until finally a determination is reached concerning an appropriate action for the affected account. In this regard, in one example implementation the computer-executable decision logic 54 can comprise logic such as that included in WO/2007/077006, PCT/EP2006/012587, entitled OPTIMIZED RESERVATION OF CHARGES FOR MULTIPLE COMMUNICATION SERVICES AND/OR SERVICE TYPES, which is incorporated by reference in its entirety herein.

Thus, by evaluating at least one and possibly plural conditional factors, the tree of computer-executable decision logic 54 defines what action is appropriate for the current cyclical job (knowing the current cyclical job by its Cycle_Id). One such conditional factor, which is the first conditional factor of the tree for each Account_Id, is the Cycle_Id of the current cyclical job now being executed. Other conditional factors can involve or invoke (e.g., depend upon) information about the affected account as such information is obtained from computer-readable medium 38.

The types of subscriber or account information upon which conditions or routing through the decision tree of computer-executable decision logic 54 can be based are myriad. For example, such subscriber or account information can include account data (e.g., account balance, subscriber class, expiration date); current location of a mobile terminal (if the terminal is a mobile terminal in a radio access network); accumulated service usage; type of subscription associated with or attributed to the account; community(ies) to which the subscriber may belong; characteristics or biographical information of a person to whom the account belongs; and services for which the account is registered or entitled to participate, just to name a few.

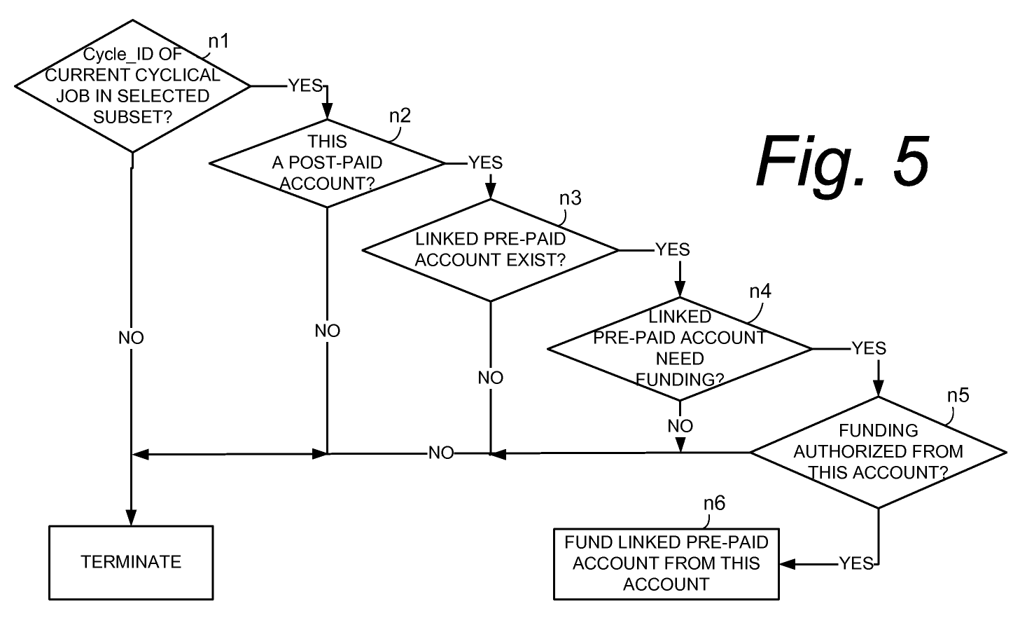

As an example, one sample version of computer-executable decision logic 54 can have the evaluation nodes illustrated in FIG. 4 in its decision tree. FIG. 4 is representative of example execution of computer-executable decision logic 54 for one representative affected account. At Node N1 of FIG. 4 the computer-executable decision logic 54 evaluates whether the Cycle_Id of the current cyclical job belongs to a prescribed subset of accounts. If so, the evaluation continues with Node N2; otherwise the computer-executable decision logic 54 for the affected account is terminated. At Node N2 the computer-executable decision logic 54 determines whether a particular date (i.e., today, the date of execution of the current cyclical job) is the birthday of the account holder. The computer-executable decision logic 54 makes the determination of Node N2 with resort or reference to a record for the affected account, such record being stored in on a medium such as computer-readable medium 38, for example. If the determination of Node N2 is positive (i.e., today is in fact the birthday of the account holder), evaluation continues with Node N3; otherwise the computer-executable decision logic 54 for the affected account terminates. At Node N3 the computer-executable decision logic 54 determines whether the account is more than two years old (i.e., whether the account has been established or open for more than two years). The determination of Node N3 can also be made with reference to the record for the affected account (e.g., in computer-readable medium 38). If the determination of Node N3 is positive (i.e., if the account is more than two years old), processing continues at Node N4; otherwise processing continues at Node N6. At Node N4 the computer-executable decision logic 54 determines whether the equipment for the account has texting service (such information also being obtainable from the account record in computer-readable medium 38). If the determination of Node N4 is positive, processing continues at Node N5; otherwise processing terminates. Node N5 comprises initiation of a first possible appropriate action for the affected account, and particularly the sending of the following text message to the equipment associated with the account: “Happy Birthday from your telephone company. As a gift, today you may download any ring tone for free.” Node N5 also includes notifying the billing system that any download of a ring tone occurring today is not to be charged to the affected account. Node N6, entered upon determining (at Node N4) that the account has not been open for more than two years, involves the computer-executable decision logic 54 determining whether the equipment for the account has texting service (such information also being obtainable from the account record in computer-readable medium 38). If the determination of Node N6 is positive, processing continues at Node N7; otherwise processing terminates. Node N7 comprises initiation of a second possible appropriate action for the affected account, and particularly the sending of the following text message to the equipment associated with the account: “Happy Birthday from your telephone company”.

The foregoing discussion of FIG. 4 serves as one non-exhaustive illustration of the type of decision tree logic that can be employed by computer-executable decision logic 54, as well as invoking account-dependent information for conditional evaluations of computer-executable decision logic 54. While the computer-executable decision logic 54 may, in simple situations, involve only one condition (such as the Cycle_Id associated with the affected account), FIG. 4 particularly illustrates a scenario of a more complex collection of conditions based on information related to the affected account and which information is already stored in other external places such as computer-readable medium 38.

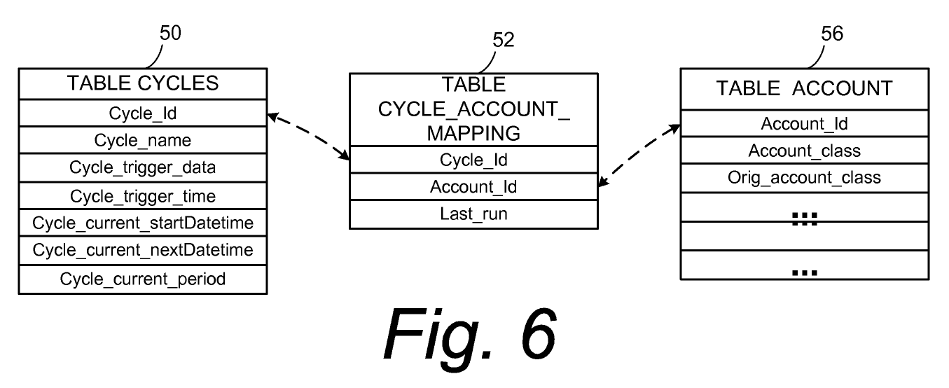

FIG. 5 illustrates yet another example scenario of computer-executable decision logic 54. At Node n1 of FIG. 5 the computer-executable decision logic 54 evaluates whether the Cycle_Id belong to a prescribed subset of accounts. If so, the evaluation continues with Node n2; otherwise the computer-executable decision logic 54 for the affected account is terminated. At Node n2 of FIG. 5 the computer-executable decision logic 54 determines whether the affected account is a post-paid account. If the affected account is post-paid, execution continues with Node n3; otherwise execution terminates. At Node n3 of FIG. 5 the computer-executable decision logic 54 determines whether there is another account, which is a pre-paid account, which is linked to the affected account. If another such account exists, execution continues with Node n4; otherwise execution terminates. At Node n4 of FIG. 5 the computer-executable decision logic 54 determines whether the linked, pre-paid account needs funding. If funding is needed for the linked pre-paid account, execution continues with Node n5; otherwise execution terminates. At Node n5 of FIG. 5 the computer-executable decision logic 54 determines whether the affected account has authorized funding for the linked, pre-paid account. If funding is authorized for the linked pre-paid account, execution continues with Node n6; otherwise execution terminates. Node n6 comprises initiation of an appropriate action for the affected account, and particularly the transfer of posting of a charge to the affected account to reflect funding of the linked, pre-paid account. The appropriate action of Node n6 can include, in addition to the transfer, the sending of a notification to the owner of the affected account that the funding/transfer has occurred.

From the foregoing it should further be appreciated that the computer-executable decision logic 54 is flexible and programmable by operator to dynamically include or exclude various conditions, opportunities, or offers as the operator may deem appropriate. Thus, an appropriate action for an affected account can be discerned or defined with use of the computer-executable decision logic 54, and using the computer-executable decision logic 54 can result in appropriate actions being triggered to certain subscriptions at pre-defined and recurring times. Indeed there can be different decisions (e.g., different appropriate actions) for different affected accounts belonging to the same Cycle_Id

Mention is made above of account information stored in other external places such as computer-readable medium 38. FIG. 3 shows a portion of such account information as stored in a table such as Table Account 56 for just one account. Table Account 56 is an already existing table in a Service Data Point (SDP) which holds any kind of account information related to a particular account (The Account table 56 can represent the account for a subscriber). It will be appreciated that a similar table such as Table Account 56 exists for each account. The Table Account 56 can have many fields, including an Account_Id field; an Account_class field; and an Orig_account_class field as shown in FIG. 3. Account_class & Orig_account_class are just two examples of account data and relates to the service class of the account. (service class determines the characteristic of the account, such as expiry date of the account, allowed credit limit, etc.). The Table Account 56 can comprise many other fields such as (for example) those which would be utilized for the example evaluations of FIG. 4 or other information regarding the account, such as account balance and/or account activation date.

Both FIG. 4 and FIG. 5 above provide some examples of appropriate actions that can result or be taken for an affected account as a result of invocation of computer-executable decision logic 54. The appropriate actions which are prompted by computer-executable decision logic 54 for an affected account can include generation of a notification, and the notifications can be delivered in various ways. For example, a notification can be an electronic notification, a telephonic notification (e.g., recorded voice message), or a printed notification (e.g., a notification for postal mailing). Examples of electronic notification can include an email notification or a text message notification. The notifications can be informational notifications or financial notifications (e.g., the sending of an invoice). Another appropriate action for an affected account can be performance of a financial transaction, such as a funds transfer or the like.

In one example situation, if the triggered Cycle_Id is defined for bill cycle management, an order can be sent to the billing system to do a bill run for this particular subscription (or for every subscription belonging to this Cycle_Id). In another example situation, if the triggered Cycle_Id is defined for notification cycle management, an order is sent to the notification system to give the subscriber (or every subscriber belonging to this Cycle_Id) a particular notification (e.g. a USSD message). Although some Cycle_Ids may comprise the sending of a bill or sending of a notification to all affected accounts, in other scenarios differing appropriate actions may result and be undertaken with respect to differing affected accounts associated by the Cycle_Id.

In view of the foregoing, the action generator 32 can take diverse and plural forms. For example, as illustrated in FIG. 1, action generator 32 can be realized by one or more of a printer; a record generator (for generating or modifying records stored on medium such as computer-readable medium 38); an email generator; a telephone voice message generator; or a transaction generator (e.g., for generating a financial transaction such as crediting or debiting an affected account and/or a bank account associated with the affected account).

Act 3-6 of FIG. 3 comprises cycle management logic 42 updating the parameter/field Last_run in Table Cycle_Account_mapping 52 for the affected account. In particular, the date and time of execution of the appropriate action for the affected account is loaded into the Last_run field of Table Cycle_Account_mapping 52, thereby marking the affected account as completed with respect to this Cycle_Id.

Act 3-7 of FIG. 3 comprises cycle management logic 42 checking to verify whether all affected accounts for this Cycle_Id have been processed. If other affected accounts for this Cycle_Id (this current cyclical job) have yet to be processed, those remaining affected accounts are processed by cycle management logic 42 in the context of the current cyclical job as depicted by arrow 58.

Act 3-8 is executed only after all affected accounts associated with the Cycle_Id of the current cyclical job have been processed. Act 3-8 of FIG. 3 comprises cycle management logic 42 moving the value Cycle_current_nextDateTime (which was the triggering date and time for this Cycle_Id) to a location Cycle_current_startDateTime, and then calculating a new value for the field Cycle_current_nextDateTime before the next comparison of act 3-2.

The calculation of the new value for the field Cycle_current_nextDateTime can depend on the value of the field Cycle_current_startDateTime, as well as the field Cycle_trigger_date and the field Cycle_trigger_time. The field Cycle_trigger_time includes a defined trigger time at the trigger date (e.g., the date in the field Cycle_trigger_date) when to trigger operation of cycle management logic 42for the current cyclical job. Typically the value in field Cycle_trigger_time is in terms of an hour (or possibly an hour and minutes) of the day. The value in the field Cycle_trigger_date, which is the defined trigger date when to trigger use of cycle management logic 42 for the current cyclical job, is understood by reference to Table 1.

TABLE 1
Cycle_trigger_date FIELD

| Field contents | Meaning |
|---|---|
| ****_**_** | Each year, each month, and each day, |
| | (i.e., every day always) |
| ****_**_DD | Each year, each month at date DD, e.g., |
| | on the 28^{th} day each month every year |
| ****_MM_** | Each day during month MM every year |
| ****_MM_DD | Each year at month MM and date DD, |
| | e.g., on January 1 each year |
| YYYY_**_** | Every day during year YYYY |
| YYYY_**_DD | At date DD every month during year |
| | YYYY |
| YYYY_MM_** | Every day during month MM in year |
| | YYYY |
| YYYY_MM_DD | Only once at the exact date given |
| YYYY_MM_DD/n | From the exact date YYYY_MM_DD |
| | and n days (n > 1) |

FIG. 6 shows each of Table Cycles 50, Table Cycle_Account_mapping 52, and Table Account 56 in one view, including how some fields are common to each of these tables. The field Cycle_current_period in Table Cycles 50 is a sequential number identifying the current period, e.g., YYYYMM. The format of the field Cycle_current_period is preferably related to the field Cycle_trigger_date.

Act 3-9 of FIG. 3 comprises the cycle management logic 42 determining whether all current cyclical jobs which were determined at act 3-2 as being timely have, in fact, been executed. It should be remembered in this regard that it is possible that several jobs were determined at act 3-2 to be due for execution, and that these several jobs may all be conceptualized as current cyclical jobs. In a case in which there are in fact plural current cyclical jobs, the current cyclical jobs can be executed essentially concurrently or seriatim. But the purpose of act 3-9 is to ensure that all current cyclical jobs have terminated. If not, any remaining current cyclical job that has not been executed is commenced (as indicated by the negative arrow from the symbol of act 3-9), or conclusion of execution of any already-begun but yet unfinished current cyclical job is awaited. If the determination of act 3-9 is positive, then cycle management logic 42 awaits another scheduled execution or triggering (e.g., awaits a repetition of act 3-1). In other words, when all current cyclical jobs have been scanned and execution thereof completed, the cycle management logic 42 can stop and wait for a new scheduled job or an external trigger to activate a new scanning or it can restart the scanning automatically.

The implementation of cycle management logic 42 can be realized in a Service Data Point (SDP), which is a node or machine that holds the account and its data. The Service Data Point (SDP) also calculates usage costs and withdraw money from the account in real time. The implementation of cycle management logic 42 can utilize a database which already exists in a billing and/or charging system, or new databases. As mentioned above, FIG. 6 shows example formats and relationships of Table Cycles 50, Table Cycle_Account_mapping 52, and Table Account 56. The Table Cycle_Account_mapping 52 is used to define which cycles are defined for each account and further indicates (in field Last_run) the last date/time a specific cycle for a specific account did run. The field Account_Id identifies a particular Account or a group of accounts. The field Last_run defines the date (and possibly also the time) when a particular current cyclical job (Cycle_Id) was run for a particular account.

Each subscription can belong to several jobs, e.g., to several Cycle_Ids. Each Cycle_Id can be (and usually is) assigned to several subscriptions, e.g., have plural affected accounts. Each Cycle_Id also has a Cycle_current_trigger_date & Cycle_current_trigger_time, as well as a valid timeframe. The current triggering date is automatically updated after the latest trigger.

It will be appreciated that several instances of the logic, e.g., several instances of cycle management logic 42, could run or execute in parallel.

The technology disclosed herein enables general cycle management to handle all types of cyclic jobs, including existing jobs and jobs developed in the future. If a need for a new type of cycle management arises, no re-design is necessary, rather a matter of configuration. This will save many design hours and will shorten the lead-time to market for any new cycle management which may be needed.

The technology disclosed herein will also render a charging system more flexible when it comes to handling of different kinds of cyclic jobs. The technology disclosed herein will also permit a charging system to take a further step into the area of convergent charging.

The description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An accounts management node of a communications system comprising:
a computer comprising one or more processors and configured, after initiation of a current cyclical job, to use computer-executable decision logic for determining what appropriate output action is to be taken with respect to each of plural affected accounts;
a generator under control of the computer and configured automatically to generate an appropriate output action for each affected account

2. The node of claim 1, wherein the computer is configured to execute instructions stored on a computer-readable medium for performing the acts of:
determining at least one cyclical job is to be executed as the current job upon attainment of an input time;
determining which of plural subscriber accounts are the plural affected accounts associated with the current job; and then
in the course of execution of the current job, for each of the plural affected accounts, employing the computer-executable decision logic to make a separate determination of an appropriate output action to be taken for the respective affected account, the determination being made in dependence upon subscriber-related information stored in a computer-readable database; and
wherein the generator is automatically responsive to the acts performed by the computer and configured to perform the appropriate output action.

3. The node of claim 2, wherein the computer is further configured to execute the instructions stored on the computer-readable medium to employ the computer-executable decision logic to make a separate determination for each affected account, and wherein the subscriber-related information is not uniform for all affected accounts associated with the current job.

4. The node of claim 2, wherein the computer is further configured to execute the instructions stored on the computer-readable medium whereby act (1) comprises comparing the input time with respective trigger times for each of the plural cyclical jobs, a trigger time being stored in a computer-readable record for the current job, and wherein the computer is further configured to execute the instructions stored on the computer-readable medium for performing the acts of:
(a) using criteria stored in the computer-readable record for the current job to calculate a new trigger time for the current job;
(b) storing the new trigger time in the record for the current job as the trigger time;
(c) repeating act (1) using the new trigger time as the trigger time for the current job.

5. The node of claim 3, wherein the computer is further configured to execute the instructions stored on the computer-readable medium to perform acts (a)-(c) after acts (2)-(4) have been performed for all affected accounts associated with the current job.

6. The node of claim 2, wherein the computer is further configured to execute the instructions stored on the computer-readable medium to set a flag in a computer-readable record for the current job that the current job is being executed.

7. The node of claim 2, wherein the computer is further configured to execute the instructions stored on the computer-readable medium, while performing any of act (1) through act (4) for a first current task, to initiate act (1) with a new input time as the input time to determine a further current task, and then to perform act (2) through act (4) with respect to the further current task.

8. The node of claim 2, wherein at least one of the affected accounts for the current job is a pre-paid account.

9. The node of claim 2, wherein at least one of the affected accounts for the current job is a post-paid account.

10. The node of claim 2, wherein at least some of the affected accounts for the current job are pre-paid accounts and at least some of the affected accounts for the current job are post-paid accounts.

11. The node of claim 2, wherein the appropriate output action for at least one of the affected accounts comprises generation of a notification.

12. The node of claim 11, wherein the notification is an electronic notification.

13. The node of claim 11, wherein the notification is a telephonic notification.

14. The node of claim 11, wherein the notification is a printed notification.

15. The node of claim 2, wherein the appropriate output action for at least one of the affected accounts comprises performance of a financial transaction.

16. A method of operating an account management node of a communications system, the method comprising:
(1) determining by a computer at least one cyclical job to be executed as a current job upon attainment of an input time;
(2) determining by the computer which of plural subscriber accounts are affected account(s) associated with the current job; and then
(3) in the course of execution of the current job by the computer for each affected account(s) employing computer-executable decision logic to make a determination of an appropriate output action to be taken for the respective affected account, the determination being made in dependence upon subscriber-related information stored in a computer-readable database; and
(4) the computer automatically initiating performance of respective appropriate output actions for the plural affected accounts.

17. The method of claim 16, further comprising employing the computer-executable decision logic to make a separate determination for each affected account, and wherein the subscriber-related information is not uniform for all affected accounts associated with the current job.

18. The method of claim 16, wherein act (1) comprises comparing the input time with respective trigger times for each of the plural cyclical jobs, a trigger time being stored in a computer-readable record for the current job, and wherein the method further comprises:
(a) using criteria stored in the computer-readable record for the current job to calculate a new trigger time for the current job;
(b) storing the new trigger time in the record for the current job as the trigger time;
(c) repeating act (1) using the new trigger time as the trigger time for the current job.

19. The method of claim 18, further comprising performing acts (a)-(c), after acts (2)-(4) have been performed for all affected accounts associated with the current job.

20. The method of claim 16, wherein act (2) comprises setting a flag in a computer-readable record for the current job that the current job is being executed.

21. The method of claim 16, further comprising, while performing any of act (1) through act (4) for a first current task, initiating act (1) with a new input time as the input time to determine a further current task, and then performing act (2) through act (4) with respect to the further current task.

22. The method of claim 16, wherein at least one of the affected accounts for the current job is a pre-paid account.

23. The method of claim 16, wherein at least one of the affected accounts for the current job is a post-paid account.

24. The method of claim 16, wherein at least some of the affected accounts for the current job are pre-paid accounts and at least some of the affected accounts for the current job are post-paid accounts.

25. The method of claim 16, wherein the appropriate output action for at least one of the affected accounts comprises generation of a notification.

26. The method of claim 25, wherein the notification is an electronic notification.

27. The method of claim 25, wherein the notification is a telephonic notification.

28. The method of claim 25, wherein the notification is a printed notification.

29. The method of claim 16, wherein the appropriate output action for at least one of the affected accounts comprises performance of a financial transaction.
